(19) United States
(12) Patent Application Publication
(10) Pub. No.: US 2008/0282110 A1
(43) Pub. Date: Nov. 13, 2008

(54) SCAN CLOCK ARCHITECTURE SUPPORTING SLOW SPEED SCAN, AT SPEED SCAN, AND LOGIC BIST

(76) Inventor: Amar Guettaf, Sunnyvale, CA (US)

Correspondence Address: MCANDREWS HELD & MALLOY, LTD, 500 WEST MADISON STREET, SUITE 3400, CHICAGO, IL, 60661, US

(21) Appl. No.: 11/746,477

(22) Filed: May 9, 2007

(51) Int. Cl. G06F 11/00

(52) U.S. Cl. 714/30

(57) ABSTRACT

Herein described are at least a method and a system to perform scan testing of an integrated circuit chip using one or more internal and external clock sources. In a representative embodiment, the method comprises receiving at least one external clock signal and three control signals generated by an off-chip clock source, generating at least one internal clock signal from an on-chip clock source, and using the at least one external clock signal and the at least one internal clock signal by a logic circuitry to generate one or more scan test clocks to perform scan testing of one or more corresponding clock domains. In a representative embodiment, the system comprises at least one on-chip clock source and first and second circuitries for generating a scan test clock for a clock domain.

### BACKGROUND OF THE INVENTION

When scan testing is performed on a digital integrated circuit chip, it is important to be able to provide one or more appropriate scan clocks. Typically, an external clock source provides the one or more scan clocks by way of one or more pins on the integrated circuit chip. Because of the electrical characteristics related to the connection between the external clock source and the digital integrated circuit chip, the signal quality of the one or more scan clocks may suffer. As a consequence, the maximum clock frequency of each of the one or more scan clocks may be limited. If the one or more scan clocks are limited to a particular frequency, the one or more scan clocks may be inadequate for performing “at speed testing” or “transition fault delay testing” of a digital integrated circuit, for example. Furthermore, if one or more scan clocks provided to the integrated circuit chip are noisy, the results of such scan testing may be inaccurate.

The limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

Various aspects of the invention provide a method and a system of scan testing an integrated circuit chip by way of using both internal and external clock sources. The various aspects and representative embodiments of the method and system are substantially shown in and/or described in connection with at least one of the following figures, as set forth more completely in the claims.

These and other advantages, aspects, and novel features of the present invention, as well as details of illustrated embodiments, thereof, will be more fully understood from the following description and drawings.

### BRIEF DESCRIPTION OF THE DRAWINGS

FIG. 1 is a block diagram of an integrated circuit chip utilizing internal and external clock sources for generating one or more scan clocks for use in the scan testing of one or more clock domains, in accordance with an embodiment of the invention.

FIG. 2 is a block diagram of a scan clock generation module (SCGM), in accordance with an embodiment of the invention.

FIG. 3 is an operational flow diagram describing scan testing of an integrated circuit chip using one or more external and internal clock sources, in accordance with an embodiment of the invention.

### DETAILED DESCRIPTION OF THE INVENTION

Various aspects of the invention can be found in a method and a system of generating one or more scan clocks used in the scan testing of one or more scan chains in an integrated circuit chip. In a representative embodiment, the method and system generates one or more scan clocks used for testing flip-flops in one or more clock domains. In a representative embodiment, the system comprises on-chip circuitry that is used to generate one or more scan clocks for performing at least a slow speed scan test, an at speed scan test, and a logic built-in-self-test (BIST) of the one or more flip-flops in one or more clock domains of the integrated circuit chip. Hereinafter, the on-chip circuitry may be referred to as a scan clock generation module. An off-chip external source (i.e., an automatic test equipment (ATE)) may be used as a clock source to generate the one or more scan clocks for performing the slow speed scan test. An internal source may be used to generate one or more clocks for performing an at speed scan test. When performing an at speed scan test, the internal source may be used to generate a scan test clock comprising two or more consecutive high frequency pulses. The internal source may also be used to generate a high frequency scan clock suitable for performing BIST of circuitry within the integrated circuit chip. The circuitry, for example, may comprise one or more flip-flops. The BIST refers to any type of embedded state machine testing performed within the integrated circuit chip. The method comprises providing the one or more scan clocks, for the purposes of scan testing the integrated circuit chip, to one or more clock domains of the integrated circuit chip.

The one or more scan clocks used to clock one or more clock domains of the one or more scan chains may originate from a clock source originating from within the integrated circuit chip or from a clock source originating external to the integrated circuit chip. For example, an internal clock source may comprise a phase locked loop (PLL) designed within the integrated circuit chip. On the other hand, an external (i.e., off-chip) scan clock may be supplied by any equipment, such as an automatic test equipment (ATE), by inputting the external scan clock using a pin situated on the integrated circuit chip. In a representative embodiment, one or more internally generated scan clock(s) as well as one or more externally generated scan clock(s) are implemented for scan testing of the integrated circuit chip. As a consequence of using clock sources within the integrated circuit chip to generate one or more scan clocks, scan clocks with higher clock frequencies may be obtained. Such high frequency scan clocks may be useful for performing “at speed testing” of the flip-flops in one or more clocks domains of an integrated circuit chip. “At speed testing” may also be referred to as “transition fault delay testing”. The scan clocks that originate from an internal source may also exhibit very low noise compared to the scan clocks that originate from an external source. For example, because of long lead lines, the external source may transmit signals to the integrated circuit chip that are prone to parasitic inductances and capacitances. Thus, clock source signals generated external to the chip may suffer in terms of quality, and consequently, the signal to noise ratio (SNR) may be poor. As a consequence, it is advantageous to utilize an internal clock source that is capable of providing a low noise high frequency clock signal, such as a phase locked loop (PLL), within the integrated circuit chip, in accordance with the various aspects of the present invention.

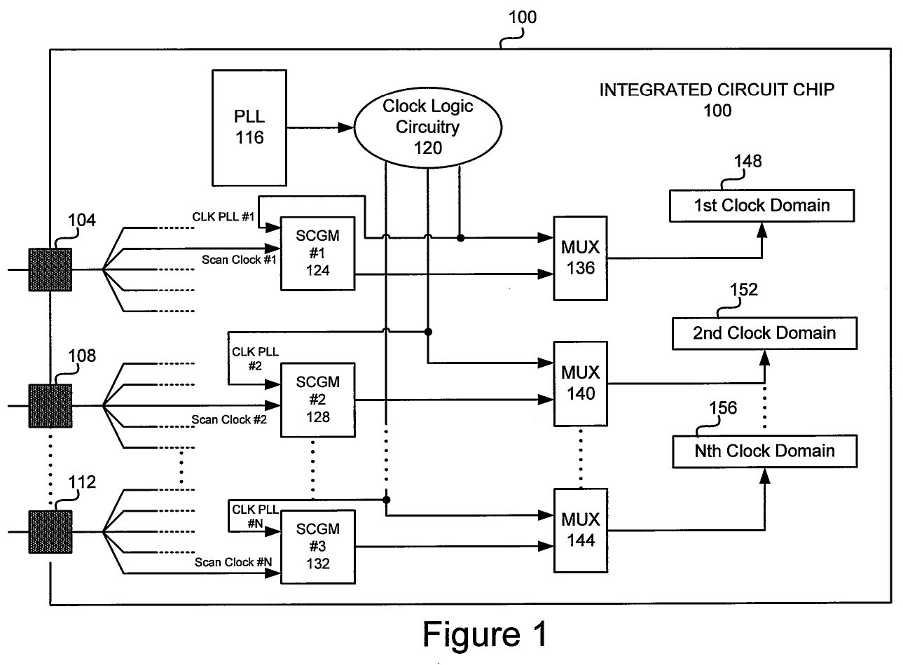

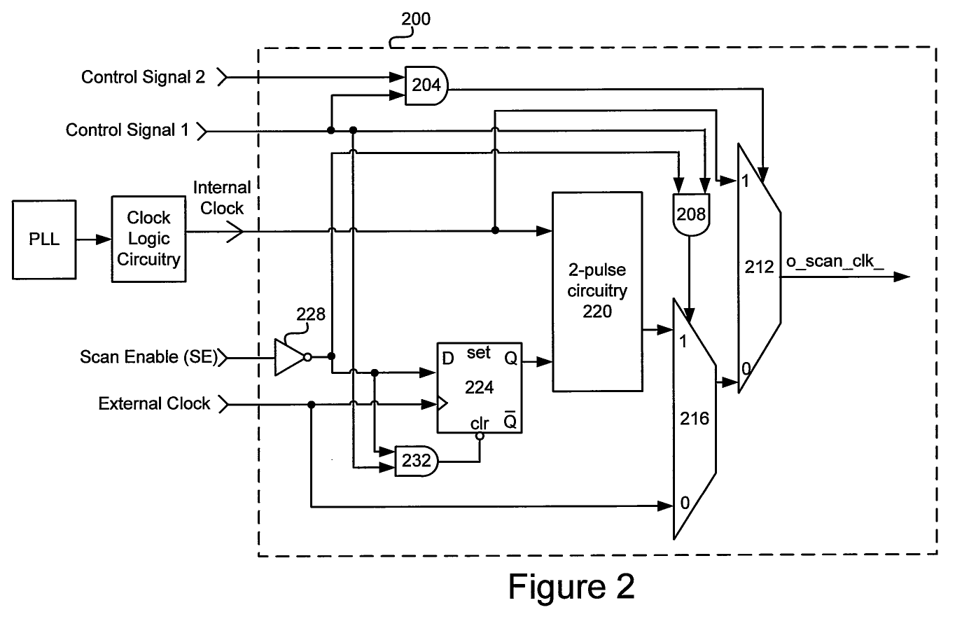

FIG. 1 is a block diagram of an integrated circuit chip 100 utilizing internal and external clock sources for generating one or more scan clocks for use in the scan testing of one or more clock domains, in accordance with an embodiment of the invention. The integrated circuit chip 100 comprises one or more scan clock generation modules (SCGMs). The one or more scan clocks may be used to perform “at speed” or “transition fault delay” testing, “slow speed” scan testing, and/or built-in-self-test (BIST) testing. The integrated circuit chip 100 comprises one or more pins. As illustrated, the one or more pins may comprise a 1^{st} pin 104, a 2^{nd} pin 108, . . . , through Nth pin 112. The one or more pins may be used for connecting to one or more external inputs. The one or more external inputs may comprise one or more external clocks provided by an external clock source. The external clock source may comprise any type of clock source such as an automatic test equipment (ATE). In the representative embodiment illustrated in FIG. 1, the first, second, and Nth pins 104, 108, 112 provide external clock signals to their corresponding SGCM. Although not shown, there are a total of N scan clock generation modules (SGCMs). The integrated circuit chip 100 comprises a 1^{st} scan clock generation module (SCGM) 124, a 2^{nd} SCGM 128, . . . , and an Nth SCGM 132. Details of an SCGM will be described in FIG. 2. The integrated circuit chip 1 00 comprises one or more multiplexers 136, 140, 144, each of which provide an output to each of the one or more clock domains 148, 152, 156. Also illustrated are the one or more clock domains 148, 152, 156, each of which receives a scan test clock provided by way of a corresponding multiplexer 136, 140, 144. The integrated circuit chip 100 comprises an internal clock source such as a phase locked loop (PLL) 116. The internal clock source generates a periodic waveform. The internal clock source (e.g., PLL) transmits its output to a clock logic circuitry 120. The clock logic circuitry 120 may comprise clock divider circuitry, counters, comparators, gates, etc. The clock logic circuitry 120 may be used to divide down the frequency of the signal generated by the PLL 116. The clock logic circuitry 120 transmits an output to each of the one or more multiplexers 136, 140, 144. The output may comprise an internal functional clock that the chip ordinarily uses for clocking flip-flops of its respective clock domain. The internal functional clock may be used to clock one or more flip-flops in a clock domain when scan testing is not performed. As shown, each of the multiplexers selects from one of two inputs. The two inputs comprise an internal functional clock or an output of a scan clock generation module. Although not shown in FIG. 1, each of the multiplexers 136, 140, 144 may utilize a control signal that selects from the two inputs. The control signal for each of the multiplexers 136, 140, 144 may be provided by way of the one or more pins on the integrated circuit chip. A control signal may determine whether scan testing is performed by way of selecting a scan clock provided to the multiplexers 136, 140, 144. Otherwise, as illustrated in the representative embodiment of FIG. 1, the internal functional clock generated by the clock logic circuitry 120 may be used when scan testing is not performed.

FIG. 2 is a block diagram of a scan clock generation module (SCGM) 200, in accordance with an embodiment of the invention. The SCGM 200 comprises a first AND gate 204, a second AND gate 208, a first multiplexer 212, a second multiplexer 216, a 2-pulse generating circuit 220, a D flip-flop 224, an inverter 228, and a third AND gate 232. As described in connection with FIG. 1, a phase locked loop outputs a waveform at a particular frequency to a clock logic circuitry. The 2-pulse generating circuit 220 may comprise one or more counters and comparators, for example. The clock logic circuitry provides an internal clock to the SCGM 200. First and second control signals are input into the SCGM 200 to control the various circuitry within the SCGM 200. The first and second control signals may be provided by an automatic test equipment (ATE), for example. The first and second control signals determine the type of scan test clock delivered to the corresponding clock domain. The clock domain comprises an optimal digital design such that all circuitry of the clock domain utilizes the same clock signal. The clock domains comprise independent clock domains. The first and second control signals comprise binary control signals; as a consequence, the control signals may be used to generate four different output possibilities. The first AND gate 204 generates an output to the control input of the first multiplexer 212. The second AND gate 208 generates an output to the control input of the second multiplexer 212. The control input of a multiplexer determines whether the input provided to the “1” input or the “0” input is selected, as illustrated in FIG. 2. The 2-pulse circuitry 220 generates two consecutive pulses when the Q output of the D flip-flop 224 undergoes a positive transition. In a representative embodiment, the pulse width of each of the two consecutive pulses is equal to the pulse width of the internal clock generated by the clock logic circuitry. The internal clock feeds into the clock input of the 2-pulse circuitry 220 while the Q output of the flip-flop 224 feeds into the trigger input of the 2-pulse circuitry 220. When control signal 2 is set to logic 0 and control signal 1 is set to logic 0, both AND gates 204, 208 output a logic 0. As a result, the external clock is passed through the two multiplexers 212, 216, and the SCGM 200 outputs the external clock as a scan test clock to its corresponding clock domain. When the external clock is transmitted to its corresponding clock domain, the integrated circuit chip may be operating in what is referred to as a normal “slow speed” scan test mode. When control signal 2 is set to logic 0 and control signal 1 is set to logic 1, the first AND gate 204 generates a logic 0 signal to the control input of the first multiplexer 212, while the output of the second AND gate 208 is controlled by a scan enable (SE) input. When the SE input is set at logic 0, the “1” input of the second multiplexer 216 is selected while the D input to the flip-flops 224 is set to logic 1. When the flip-flop 224 is clocked while SE is at logic 0, the Q output of the flip-flop makes a positive transition and the 2-pulse circuitry 220 generates 2 consecutive pulses. The 2 consecutive pulses may be used to perform “at speed” or “transition fault delay” testing of the one or more flip-flops of its corresponding clock domain after test data have been scanned in or shifted into one or more scan chains of an integrated circuit chip. When SE=0, the integrated circuit chip may operate in what is referred to as a “capture mode.” When the SE input is set at logic 1, the “0” input of the second multiplexer 216 is selected such that the external clock is passed through the two multiplexers 212, 216, and the SCGM 200 outputs the external clock as a scan test clock to its corresponding clock domain. The external clock may perform a scan in, shifting in, or shifting out of data into the flip-flops of one or more clock domains and/or scan chains of an integrated circuit. Thus, when SE=1, the integrated circuit chip may operate in what is referred to as a “scan in”, “shift-in” or shift-out mode.” When control signal 2 is set to logic 1 and control signal 1 is set to logic 1, the first AND gate 204 outputs a logic 1. As a result, the internal clock is passed through the first multiplexer 212 and the SCGM 200 outputs the internal clock as a scan test clock to its corresponding clock domain. In this case, the internal clock is used to perform built-in-self-testing (BIST) or embedded testing of the circuitry of the integrated circuit chip. When control signal 2 is set to logic 1 and control signal 1 is set to logic 0, both AND gates 204, 208 output a logic 0. As a result, the external clock is passed through the two multiplexers 212, 216, and the SCGM 200 outputs the external clock as a scan test clock to its corresponding clock domain. In this representative embodiment, the SCGM 200 outputs the same result when control signal 2 is set to logic 1 and control signal 1 is set to logic 0 compared to when control signal 2 is set to logic 0 and control signal 1 is set to logic 0. The SCGM 200 or its integrated circuit chip may operate in what is referred to as a normal “slow speed” scan test mode. The third AND gate 232 sets the flip-flop's output Q to logic 0 in all cases except for the case when the SCGM 200 operates in capture mode (i.e., SE=0). When the two inputs of the third AND gate are equal to logic 1, the output of the third AND gate 232 is logic 1 and the flip-flop 224 does not clear. Since the clear input of the flip-flop 224 is negatively enabled, clearing is absent only when the first control signal is at logic 1 while the scan enable is at logic 0, such as when the SCGM is operating in “capture mode”, for example. The two control signals and the scan enable (SE) signal may be provided to the integrated circuit chip by way of corresponding pins situated on the integrated circuit chip.

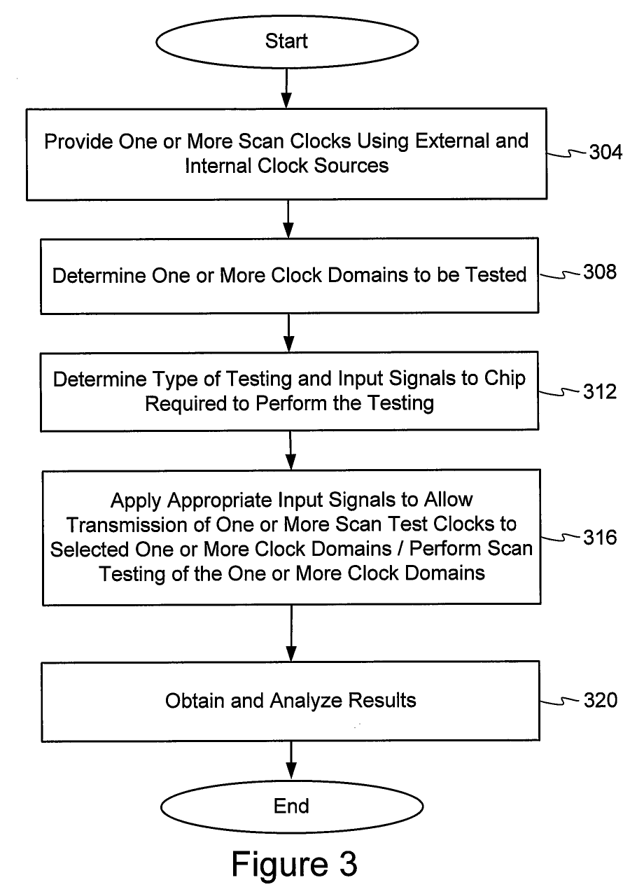

FIG. 3 is an operational flow diagram describing scan testing of an integrated circuit chip using one or more external and internal clock sources, in accordance with an embodiment of the invention. At step 304, one or more external clock sources may be supplied to the integrated circuit chip by way of one or more pins situated on the integrated circuit chip. The external clock source may comprise an automatic test equipment (ATE), for example. By way of using the one or more pins on the integrated circuit chip, one or more external clock signals, control signals, multiplexer control signals, and scan enable (SE) signals may be provided to the chip. At step 308, these signals are used to determine which of the one or more clock domains are to be tested. Next, at step 312, the appropriate signals (i.e., the one or more external clock signals, control signals, multiplexer control signals, and scan enable signals), are determined based on the type of scan testing to be performed on the one or more clock domains. For example, referring to the detailed description of a scan clock generation module (SCGM) in connection with FIG. 2, when “at speed” or “transition fault delay” testing is to be performed, the first control signal is set to logic 1 while the second control signal is set to logic 0 and the scan enable (SE) input is set to logic 0. This results in two consecutive pulses being clocked into a clock domain to facilitate the “at speed” testing. Furthermore, the associated multiplexer control signal should be set to an appropriate logic value such that the scan test signal generated by the SCGM is transmitted to its corresponding clock domain. Next, at step 316, the appropriately determined signals are applied to the integrated circuit chip such that scan testing may be performed on one or more selected clock domains. Thereafter, at step 320, the results of any scan testing may be analyzed by the ATE. For example, an input test vector, originating from the ATE, may be shifted into one or more flip-flops to perform an “at speed” test, and the resulting data stored in the one or more flip-flops may be shifted out to the ATE. The ATE may subsequently analyze the output test vector. The results of the analysis may be used to revise the design of the integrated circuit chip.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiments disclosed, but that the invention will include all embodiments falling within the scope of the appended claims.

What is claimed is:

1. A method of scan testing one or more clock domains in a digital integrated circuit chip comprising:
receiving at least one external clock signal, and three control signals generated by an off-chip clock source;
generating at least one internal clock signal from an on-chip clock source;
determining which of said one or more clock domains are to be tested;
inputting said at least one external clock signal and said at least one internal clock signal into a logic circuitry to generate one or more scan test clocks, said one or more scan test clocks transmitted to one or more corresponding said clock domains to perform said scan testing.

2. The method of claim 1 wherein said on-chip clock source comprises a phase locked loop (PLL).

3. The method of claim 1 wherein said off-chip clock source comprises an automatic test equipment (ATE).

4. The method of claim 1 wherein said three control signals determine the waveform characteristics of the scan test clock generated by said logic circuitry.

5. The method of claim 4 wherein said scan test clock comprises two consecutive clock pulses for performing transition fault delay testing.

6. The method of claim 1 wherein scan test clock comprises said at least one external clock signal.

7. The method of claim 6 wherein said at least one external clock signal performs a “slow speed” scan test.

8. The method of claim 1 wherein scan test clock comprises said at least one internal clock signal.

9. The method of claim 6 wherein said at least one internal clock signal performs a built-in-self-test (BIST) scan test.

10. The method of claim 1 wherein said logic circuitry comprises a clock divider circuitry.

11. The method of claim 1 wherein said logic circuitry comprises at least a multiplexer, at least an AND gate, and at least a D flip-flop.

12. The method of claim 1 wherein said at least one external clock signal and said three control signals are received by way of one or more corresponding pins of said integrated circuit chip.

13. An integrated circuit chip comprising:
at least one on-chip clock source;
a first circuitry for dividing the frequency of a periodic waveform provided by said at least one on-chip clock source to generate a first clock signal;
a second circuitry for:
receiving:
a second clock signal from at least one external source;
said first clock signal;
a first control signal;
a second control signal; and
a third control signal, said first, second, and third control signals determining the type of signal characteristics of a scan test clock that is generated; and
transmitting said scan test clock to a corresponding clock domain.

14. The integrated circuit chip of claim 13 wherein said first, second, and third control signals are provided by said at least one external source.

15. The integrated circuit chip of claim 13 wherein said first, second, and third control signals comprise binary values.

16. The integrated circuit chip of claim 13 wherein said scan test clock comprises 2 consecutive pulses for performing an “at speed” or “transition fault delay” test of one or more flip-flops of said corresponding clock domain when said third control signal is set to a certain value.

17. The integrated circuit chip of claim 13 wherein said scan test clock comprises said second clock signal.

18. The method of claim 17 wherein said second clock signal performs a “slow speed” scan test.

19. The integrated circuit chip of claim 13 wherein said scan test clock comprises said first clock signal.

20. The method of claim 19 wherein said first clock signal performs a built-in-self-test (BIST) scan test.

21. The integrated circuit chip of claim 13 wherein said first circuitry comprises a clock divider circuitry.

22. The integrated circuit chip of claim 13 wherein said second circuitry comprises at least a multiplexer, at least an AND gate, and at least a D flip-flop.

23. The integrated circuit chip of claim 13 wherein said on-chip clock source comprises a phase locked loop (PLL).

24. The integrated circuit chip of claim 13 wherein said at least one external source comprises an automatic test equipment (ATE).

25. An integrated circuit chip comprising:
first circuitry for generating a first clock signal, said first circuitry comprising at least one or more on-chip clock generation sources;
a second circuitry for:
receiving said first clock signal;
receiving a second clock signal from at least one external source;
receiving one or more control signals, said one or more control signals determining the type of signal characteristic of a scan test clock that is generated; and
transmitting said scan test clock to a corresponding clock domain.

26. The integrated circuit chip of claim 25 wherein said one or more control signals are provided by said at least one external source.

27. The integrated circuit chip of claim 25 wherein said one or more control signals comprise binary values.

28. The integrated circuit chip of claim 25 wherein said scan test clock comprises 2 consecutive pulses for performing an “at speed” or “transition fault delay” test of one or more flip-flops of said corresponding clock domain when a control signal of said one or more control signals is set to a certain value.

29. The integrated circuit chip of claim 25 wherein said scan test clock comprises said second clock signal.

30. The method of claim 29 wherein said second clock signal performs a “slow speed” scan test.

31. The integrated circuit chip of claim 25 wherein said scan test clock comprises said first clock signal.

32. The method of claim 31 wherein said first clock signal performs a built-in-self-test (BIST) scan test.

33. The integrated circuit chip of claim 25 wherein said first circuitry comprises a clock divider circuitry.

34. The integrated circuit chip of claim 25 wherein said second circuitry comprises at least a multiplexer, at least an AND gate, and at least a D flip-flop.

35. The integrated circuit chip of claim 25 wherein said one or more on-chip clock generation sources comprises a phase locked loop (PLL).

36. The integrated circuit chip of claim 25 wherein said at least one external source comprises an automatic test equipment (ATE).
